(19) United States
(12) Patent Application Publication
(10) Pub. No.: US 2020/0335927 A1
(43) Pub. Date: Oct. 22, 2020

(54) Method And Apparatus For A Laser Beam Diffuser

(71) Applicants: Richard Redpath, Cary, NC (US); James Redpath, Cary, NC (US)

(72) Inventors: Richard Redpath, Cary, NC (US); James Redpath, Cary, NC (US)

(21) Appl. No.: 16/389,403

(22) Filed: Apr. 19, 2019

(51) Int. Cl. H01S 3/00; G02B 5/02; G02B 5/08

(52) U.S. Cl. CPC H01S 3/0085; G02B 5/08; G02B 5/0205; G02B 5/0278

(57) ABSTRACT

The apparatus is designed to maximize the laser beam diffusion for the harsh environment of horticulture through a light optimization design. The light optimization design is an optical flat back which has a center area sized to the laser beam diameter transmission width with an optical diffusion surface surrounded with a mirror surface for an internal secondary mirror to the optical flat front. The center area optical diffusion surface back expands the laser beam transmission and the internal reflections are reflected by the secondary mirror surface through the front of the apparatus. The invention is designed to have the front surface of the apparatus exposed to the harsh environment of horticulture.

### FIELD OF THE INVENTION

The present invention relates generally to a laser beam through an optical diffuser that spreads out the beam, more particularly an apparatus that increases the amount of light from a laser beam spread for horticulture. A user of the present invention will be able to manufacture an apparatus which can be used in a harsh environment to spread out a laser beam for horticulture with the result of delivering more light at the destination.

### BACKGROUND OF THE INVENTION

Optical diffusers are used to evenly diffuse light in many applications. The diffusers cause light to spread evenly across a destination surface removing high intensity bright spots. Common diffuser types include prismatic glass integrating bars, ground glass, opal glass, holographic diffusers, and diffractive diffusers. Prismatic glass integrating bars are expensive and occupy a great deal of precious space. Ground and opal glass scatter light equally in all directions but with a low degree of control. Holographic diffusers are an improvement on these technologies and enable limited production of light distribution patterns. In general, all of these optical diffusers suffer from internal reflections of the light transmission that are not used to produce more destination light. Furthermore, some of these diffusers require facing out toward the environment and require protection.

Although these commercially available methods of spreading a laser beam for illumination produces spread light with desired properties, a significant amount of the light is lost and some of these diffusers cannot be used for the harsh environment of horticulture without protection which undermines avoiding more light lost.

Therefore, the object of the present invention is to capture the internal reflections of light and minimize the use of the diffuser surface to the size of the laser beam as to utilize the secondary mirror to reflect out the what otherwise would be the lost light to increase the efficiency of the diffuser. The present invention is to provide an optical flat with a diffuser surface that is small enough for a laser beam or collimated laser beam to impact completely with the outer surface of the optical flat having an internal secondary mirror surface for internal reflections from the transmission of the laser beam through the diffuser surface to produce more destination light for the beam diffusion. The invention is designed to have the optical surface front out to enable its use in the harsh environment of horticulture. In addition, the diffuser surface is limited to the transmission area of the laser beam as not to impact the internal reflections to be reflected by the secondary mirror.

### BRIEF DESCRIPTION OF THE DRAWINGS

FIG. 1 is a schematic view of the present invention with laser beam striking the diffuser element area.

FIG. 2 is a side cross view drawing of the present invention with laser beam striking the diffuser element area.

### DETAIL DESCRIPTIONS OF THE INVENTION

All illustrations of the drawings are for the purpose of describing selected versions of the present invention and are not intended to limit the scope of the present invention.

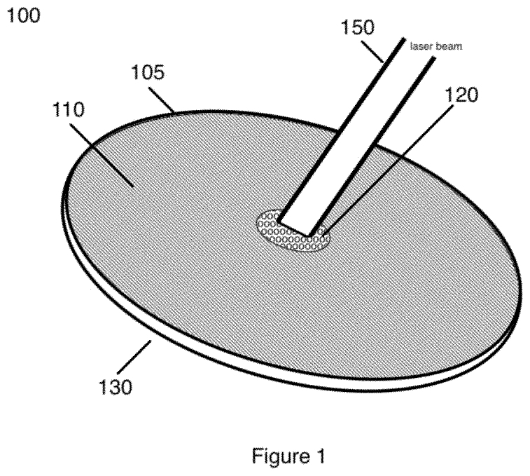

In reference to FIG. 1 at 100 is the invention back side. At 105 is an optical flat such as quartz or borosilicate glass. At 110 is a painted silver surface to produce a secondary mirror at 130 the front side of the invention. At 120 is a diffuser surface such as ground glass or a master microlens array for diffusion of a laser beam of the back side of the invention. At 150 is a laser beam that is sized in width for transmission through the diffuser surface at 120 via the back side of the invention. The invention is to have the front surface at 130 to face out to the harsh horticulture environment thereby not effecting the painted silver surface at 110 and the diffusion surface at 120 on the back side of the invention.

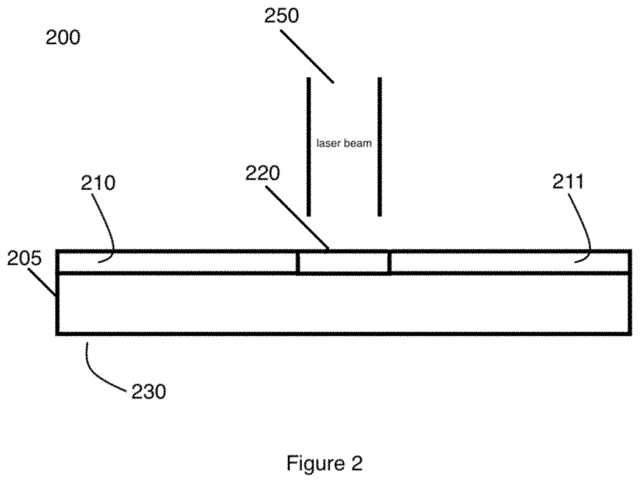

In reference to FIG. 2 at 200 is a side cross view of the invention. At 205 is an optical flat such as quartz or borosilicate glass. At 210 and 211 the back side of the invention shown is a painted silver surface to produce a secondary mirror at 230 the front side of the invention. At 220 is a diffuser surface such as ground glass or a master microlens array for diffusion of a laser beam of the back side of the invention. At 250 is a laser beam that is sized in width for transmission through the diffuser surface at 220 via the back side of the invention. The invention is to have the front surface at 230 to face out to the harsh horticulture environment thereby not effecting the painted silver surface at 210 and 211 and the diffusion surface at 220 on the back side of the cross sectional view of the invention.

What is claimed is:

1. A method and apparatus for a laser beam diffuser comprising:
a coherent light source;
an optical flat with a centered diffuser back surface to accommodate the width of the coherent light source width transmission;
the optical flat having a completely covered mirrored back surface outward from the centered diffuser surface.

2. A method and apparatus for a laser beam diffuser in claim 1 comprises:
a coherent light source;
an emission axis of the coherent light source width directly impacting the diffuser back surface width side having an outward from the diffuser surface a painted back silver surface as a secondary mirror for the front surface of the optical flat.
